(19) United States
(12) Patent Application Publication
(10) Pub. No.: US 2014/0253834 A1
(43) Pub. Date: Sep. 11, 2014

(54) Photochromic Optical Filter Incorporating a Thermochromic Gate

(71) Applicant: RAVENBRICK, LLC, Denver, CO (US)

(72) Inventors: Wil McCarthy, Lakewood, CO (US); Wilder Iglesias, Louisville, CO (US); Christopher M. Caldwell, Denver, CO (US)

(21) Appl. No.: 14/203,085

(22) Filed: Mar. 10, 2014

Related U.S. Application Data
(60) Provisional application No. 61/775,357, filed on Mar. 8, 2013.

(51) Int. Cl. G02F 1/01; G02F 1/13

(52) U.S. Cl. CPC G02F 1/0126; G02F 1/132
USPC 349/22; 359/244

(57) ABSTRACT

An optical shutter device includes a temperature responsive gate and a photochromic attenuator arranged such that at low temperatures the device is largely transmissive to solar or other radiation within a given band of wavelengths and, at high temperatures, the device is largely nontransmissive when a flux of trigger wavelengths is present and largely transmissive when a flux of trigger wavelengths is not present.

### CROSS REFERENCE TO RELATED APPLICATIONS

This application claims the benefit of priority pursuant to 35 U.S.C. §119(e) of U.S. provisional patent application No. 61/775,357 entitled “Photochromic optical filter incorporating a thermochromic gate” filed on 8 Mar. 2013, which is hereby incorporated by reference in its entirety for all purposes.

This application is related to U.S. patent application Ser. No. 13/150,475 filed 1 Jun. 2011 entitled “Multifunctional building component”; U.S. patent application Ser. No. 12/916,233 filed 29 Oct. 2010 entitled “Thermochromic filters and stopband filters for use with same”; and U.S. Pat. No. 7,768,693 issued 3 Aug. 2010 entitled “Thermally switched optical downconverting filter”; and the disclosures of each are hereby incorporated by reference herein in their entireties.

### BACKGROUND

1. Technical Field

The subject matter described herein relates to a photochromic optical shutter device that incorporates one or more thermochromic gates. Implementations of such devices have application in passive or active light-regulating and temperature-regulating films, materials and devices, including construction materials.

2. Description of the Related Art

The problem of controlling the flow of radiant energy, e.g., light and heat, in particular in applications such as regulating solar heat gain in buildings and in other applications has previously been addressed using many optical and infrared methodologies. Photodarkening materials have been used for decades, for example, in sunglass lenses, to selectively attenuate incoming light when stimulated by ultraviolet (UV) radiation. When incorporated into windows, such materials can be used to regulate the internal temperature of a structure by darkening to attenuate bright sunlight, and by becoming transparent again to allow artificial light or diffuse daylight to pass through unimpeded. Such systems are passive and self-regulating, requiring no external signal other than ambient UV light in order to operate. However, because they are controlled by UV light rather than by temperature, such systems are of limited utility in temperature-regulating applications. For example, they may block wanted sunlight in cold weather as well as unwanted sunlight in hot weather. They also may not function if placed behind a UV-blocking material such as the transparent, spectrally-selective and low-emissivity coatings that are commonly employed in the window industry.

Conversely, thermochromic attenuators (whether absorptive, reflective, or diffusive, and whether thermotropically actuated or based directly upon thermochromic molecules or compounds whose absorption, reflection, or diffusion of photons varies with temperature) are capable of switching based purely on temperature. Since the surface temperature of a window is a much better predictor of excessive solar heat gain than the level of ambient solar UV radiation, thermochromic “smart windows” may exhibit higher energy savings and comfort improvements than photochromic “smart windows”. However, thermochromic attenuators that rely on phase transitions (e.g., the transition between the liquid crystalline nematic and isotropic phases in a mesogenic material) may exhibit abrupt switching between bleached and tinted states. While this generally provides higher energy savings than a gradual transition, some users (e.g., building occupants) may find a more gradual transition (such as that provided by a photochromic attenuator) to be more aesthetically pleasing.

In addition, thermochromic filters may tint during hot weather even when not in direct sunlight, which some users may find undesirable. Furthermore, in some cases a photochromic material (e.g., a UV-transparent polymer doped with molecules of a UV-responsive azo dye) may be less expensive than a thermotropic attenuator based on liquid crystal and polarizers. Finally, in some cases a photochromic filter may be more durable than a thermochromic filter.

U.S. Pat. No. 7,768,693 to McCarthy et. al. discloses an optical filter that can be used as a window film or other light- and heat-regulating building material, that incorporates a thermotropic Distributed Bragg Reflector (DBR) that is capable of reflecting a range of wavelengths (whether UV, visible, infrared, or any combination thereof) when heated above a threshold transition temperature, while being largely transparent to the same range of wavelengths when cooled below the threshold transition temperature. In a various embodiments, the thermotropic DBR is liquid crystal based, although other arrangements are contemplated as well.

In addition, U.S. Pat. No. 7,768,693 to McCarthy et. al. and U.S. patent application publication nos. 2011/0102878 and 2011/0292488 disclose an optical filter that can be used as a window film or other light- and heat-regulating building material that incorporates a photochromic attenuator that tints in response to light radiation within a range of trigger wavelengths.

Additionally there are other examples of thermotropic DBRs (e.g., U.S. Pat. No. 7,973,998 to Xue) and photochromic attenuators (e.g., U.S. Pat. No. 4,913,544 to Rickwood et. al.) employed as “smart window” filters for glare control and/or HVAC energy savings in buildings.

The information included in this Background section of the specification, including any references cited herein and any description or discussion thereof, is included for technical reference purposes only and is not to be regarded as subject matter by which the scope of the invention is to be bound.

### SUMMARY

In exemplary implementations, a thermotropic optical shutter (i.e., a temperature-controlled, non-electrical, thermoabsorptive or thermoreflective filter) serves as a “gate” for the radiation wavelengths used to trigger a photochromic filter may be provided. The thermotropic optical shutter may be used in conjunction with a photochromic attenuator. Thermotropic optical shutters incorporating polarizing films may be useful as energy-regulating building materials, including “smart” window films that tint when heated.

In an exemplary implementation, a thermally triggered optical “gate” may be placed in front of a photochromic attenuator, such that at low temperatures the gate is highly opaque (absorptive or reflective) to the switching wavelengths (e.g., solar UV) of the photochromic attenuator. In this condition, the photochromic attenuator does not activate and remains in its bleached or transparent state. Alternately, at high temperatures the thermally triggered gate is highly transparent to these same switching wavelengths, allowing the photochromic attenuator to tint under the influence of the wavelengths.

In various embodiments, the thermally triggered optical gate is a cholesteric or chiral nematic liquid crystal with a rotation pitch selected to form a Distributed Bragg Reflector (DBR) that reflects UV radiation but is largely transparent and nondiffusive to visible and NIR radiation. In the various embodiments, the liquid crystal may have a clearing point close to room temperature (e.g., between 10° C. and 45° C.), and above this temperature it transitions from the cholesteric/chiral nematic state to an isotropic state, and the helical DBR structure disappears such that the liquid crystal no longer reflects UV radiation, and is substantially transparent to UV, visible, and NIR radiation. In this hot state, the UV radiation passes freely to the photochromic layer, which in this embodiment is a UV-transparent polymer impregnated with one or more azo dyes that are normally transparent, but in their UV-activated state absorb visible light, near-infrared light, or both.

However, numerous other types of thermally triggered gates and photochromic attenuators could be used, each of which may be either absorptive, specularly reflective, or diffusively reflective, or any combination thereof, across one or more wavelength ranges and triggered by stimuli whose precise values (i.e., temperature, light intensity, or light wavelength) can be adjusted at the time of manufacture to optimize the energy savings, glare control, or aesthetic properties of the device.

In accordance with various embodiments, the technologies as discussed herein may provide various benefits. In various examples, a “smart window” filter may be allowed to enjoy the advantages of both thermochromic and photochromic properties. In various examples, a gradual rather than abrupt transition between bleached and tinted states may be achieved. In various examples, high tint levels may be achieved on a surface in response to being exposed to direct sunlight, with the surface being largely transparent at night and on the shaded faces of a building. In various examples, lower costs, greater durability, and/or larger “throw” may be achieved than may otherwise be achieved using thermochromic or thermotropic filters alone.

### BRIEF DESCRIPTION OF THE DRAWINGS

FIG. 1 is a schematic representation of an exemplary embodiment of an optical shutter device in a cold (non-tinting) state, wherein a thermotropic DBR formed of cholesteric or chiral nematic liquid crystal is placed in front of a photochromic attenuator, blocking UV radiation such that the photochromic attenuator does not activate even when exposed to direct UV radiation from a radiant energy source such as the sun.

FIG. 2 is a schematic representation of the exemplary embodiment of FIG. 1 in a hot (photochromically tinting) state, wherein the liquid crystal has “melted” into an isotropic state and does not reflect or otherwise block UV or other radiation, such that the photochromic attenuator is capable of receiving and tinting under the influence of UV radiation from ambient sources (e.g., sunlight).

### DETAILED DESCRIPTION

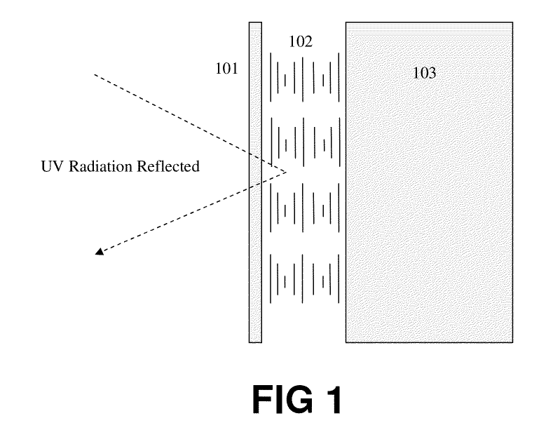

FIG. 1 is a schematic representation of an exemplary embodiment of an optical shutter device in the cold (nontinting) state, wherein a thermotropic Distributed Bragg Reflector or DBR (102), formed of cholesteric or chiral nematic liquid crystal, is encapsulated between a containment film (101) and a photochromic attenuator (103). In an exemplary implementation, the liquid crystal (LC) cell gap is about 5 microns. The LC itself may be a mixture of short, UV-stable cyanobiphenyls along with an amount of S8 chiral dopant sufficient to create a cholesteric pitch of ˜λ, where λ, is the peak activation wavelength for the photochromic attenuator (103), e.g., 390 nm. Cell gap may be maintained by means spacer beads (e.g. of 5 micron spacer beads) mixed with the liquid crystal at a weight concentration of about 1%, although spacers may be used at other concentrations and may alternatively be embedded in, and protrude from, either or both of the containment film (101) and the photochromic attenuator (103).

The clearing point of the liquid crystal may be selected such that the transition between the cholesteric/chiral nematic phase and the isotropic phase occurs at a temperature calculated to benefit one or more of: energy savings, glare control, or occupant comfort according to one or more comfort formulas such as ASHRAE-55 or Fanger PMV. In exemplary implementations, the clearing point may be selected by optimizing one or more computed output variables in a detailed, whole-building simulation program such as EnergyPlus, although the value may also be selected empirically, based either on rigorous criteria such as building energy consumption or on “soft” criteria such as the results of comfort or aesthetic surveys of building occupants. Physically, the clearing point value may be set to anywhere from 0° C. to 90° C. simply by adjusting the composition of the liquid crystal according to principles that are well established in the prior art. However, it may be observed that in practical terms there may be little advantage in clearing points below 5° C. or above 30° C. if the device has a cold-state transmissivity of 60% or higher, or in clearing points below 20° C. or above 45° C. if the device has a cold-state transmissivity of 30% or lower.

In exemplary implementations, the photochromic attenuator (103) may be a polymer film doped (or, less preferably, coated) with azo dyes, which react phototropically to UV radiation such that they transition from a normally transparent configuration to a configuration that absorbs photons within a particular range of wavelengths. The azo dyes may be selected to absorb in visible wavelengths, NIR wavelengths, or both, and may, for aesthetic reasons and for reasons of glare control and solar heat gain mitigation, be a metameric combination of multiple absorption peaks yielding a relatively flat response across a wide range of wavelengths.

The containment film may be composed of a material that is both UV-transparent and UV-stable, and capable of withstanding the high temperatures and large temperature variations of the environment of use (e.g., the interior of a double-paned window). PET and APET are examples of acceptable materials, although numerous other materials could be selected instead. In various embodiments, the structural matrix of the photochomic attenuator may be composed of the same material, although other materials could also be employed.

FIG. 1 depicts an exemplary implementation of an optical shutter device in a cold state, i.e., below the clearing point of the liquid crystal. In this state, the pitch of the cholesteric or chiral nematic LC forms a Distributed Bragg Reflector (DBR) which exhibits a reflection peak that coincides with the activation wavelength or wavelengths of the photochromic attenuator (103), e.g., a range of 380 to 400 nanometers, and which exhibits little or no interference reflection in the visible and NIR wavelengths. In this state, the thermotropic DBR (102) reflects ultraviolet light away (e.g. (e.g., >95%) from the device, preventing it from activating the photochromic attenuator. Thus, the photochromic attenuator remains in its most transparent state, even when the filter is exposed to direct sunlight or other radiant UV sources.

When incorporated into windows in a building, this configuration allows solar radiation to enter the building during cold weather, warming the interior and reducing the need for artificial heat and lighting.

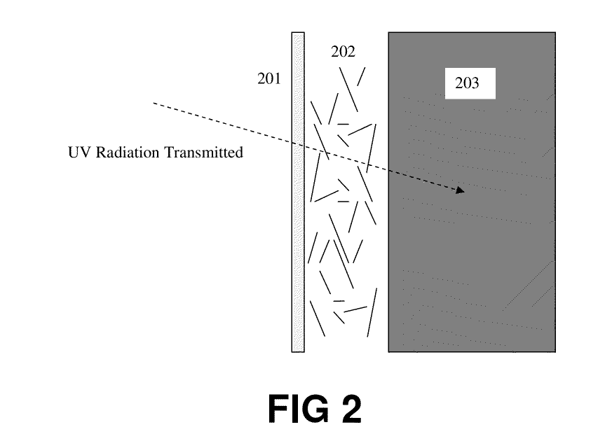

FIG. 2 is a schematic representation of FIG. 1 with the exception that the optical shutter device is in a hot (photochromically tinting) state, wherein the liquid crystal (202) has “melted” into an isotropic state and does not reflect or otherwise block UV or other radiation. In this configuration, the device transmits incident UV radiation to the photochromic attenuator (203), such that the photochromic attenuator (203) is capable tinting strongly under the influence of direct sunlight or other UV radiation, tinting mildly under the influence of indirect or scattered sunlight or other scattered UV radiation, and remaining transparent when not exposed to UV radiation, e.g. at night or in shadow.

When incorporated into a building's windows, this configuration limits the amount of solar radiation that can enter the building during warm weather, thus reducing the need for air conditioning.

It may be appreciated that other materials and operating principles could be substituted for those of the various exemplary embodiments. For example, the thermally activated gate could be absorptive, diffusive, or diffractive in nature, and could have temperature-dependent optical properties via myriad materials, structures, and devices that are known, or by other thermochromic or thermotropic principles not yet conceived, while still performing the function identified herein, i.e., selectively blocking the wavelengths of light required to trigger the photochromic attenuator. Similarly, the photochromic attenuator could be reflective, diffusive, or diffractive in nature, and could be made using a variety of photochromic or phototropic materials other than azo dyes that are known, or other materials not yet conceived, while still performing the function identified herein, of blocking radiation within a particular range of wavelengths when stimulated by radiation of the same or another range of wavelengths.

In addition, other elements may be added to the defined structure to improve its usefulness for particular applications such as smart window films. For example, a longpass filter could be added to block all UV wavelengths that may not be specifically needed to trigger the photochromic filter, so as to minimize the UV damage to materials in the device stack and thus improve its durability. Further, a low-emissivity film or coating could be added to prevent or limit heat absorbed from the device from radiating into the building interior. Various dyes or color filters may also be added to alter the aesthetic appearance of the device.

The above specification, examples and data provide a description of the structure and use of some exemplary embodiments. Although various embodiments have been described above with a certain degree of particularity, or with reference to one or more individual embodiments, those skilled in the art could make numerous alterations to the disclosed embodiments without departing from the spirit or scope of the invention. Other embodiments are therefore contemplated. All directional references e.g., proximal, distal, upper, lower, inner, outer, upward, downward, left, right, lateral, front, back, top, bottom, above, below, vertical, horizontal, clockwise, and counterclockwise are only used for identification purposes to aid the reader's understanding of the disclosure, and do not create limitations, particularly as to the position, orientation, or use of the technology. Connection references, e.g., attached, coupled, connected, and joined are to be construed broadly and may include intermediate members between a collection of elements and relative movement between elements unless otherwise indicated. As such, connection references do not necessarily imply that two elements are directly connected and in fixed relation to each other. Stated percentages of light transmission, absorption, and reflection shall be interpreted as illustrative only and shall not be taken to be limiting. Changes in detail or structure may be made without departing from the basic elements of the invention as defined in the following claims.

What is claimed is:

1. An optical shutter device comprising
an encapsulating material;
a temperature-activated optical gate that transmits one or more trigger wavelengths at high temperatures and blocks the trigger wavelengths at low temperatures, while remaining largely transparent to other wavelengths in both states; and
a photochromic attenuator capable of tinting under the influence of the trigger wavelengths; wherein
in a cold state the device exhibits a high transmission within a given wavelength band; and
in a hot state the device exhibits a low transmission within a given wavelength band when exposed to the trigger wavelengths and a high transmission within the given wavelength band when not exposed to the trigger wavelengths.

2. The device of claim 1, wherein the temperature activated optical gate is a thermotropic Distributed Bragg Reflector.

3. The device of claim 2, wherein the thermotropic Distributed Bragg Reflector incorporates a liquid crystal.

4. The device of claim 1, wherein the photochromic attenuator is a polymer film doped or coated with UV-responsive azo dyes.

5. The device of claim 3, wherein the liquid crystal comprises a short UV-stable cyanobiphenyls and an S8 chiral dopant.

6. The device of claim 5, wherein the liquid crystal is in a composition suitable to provide a cholesteric pitch at the peak activation wavelength for the photochromic attenuator.

7. A method for controlling the flow of light and heat into a building, vehicle, or other structure, comprising:
selectively blocking or transmitting a range of trigger wavelengths based on temperature; and
selectively blocking or transmitting a range of ambient wavelengths based on the flux of transmitted trigger wavelengths.
